(19) United States
(12) Patent Application Publication
(10) Pub. No.: US 2010/0009588 A1
(43) Pub. Date: Jan. 14, 2010

(54) Method of manufacturing lighted signs from electroluminescent panels

(76) Inventors: Robert B. Ray, Henderson, NV (US); David P. Lennon, Henderson, NV (US)

Correspondence Address: RICHARD A. RYAN;ATTORNEY AT LAW, 8497 N. MILLBROOK AVENUE, SUITE 101, FRESNO, CA, 93720, US

(21) Appl. No.: 12/380,775

(22) Filed: Mar. 3, 2009

Related U.S. Application Data
(60) Provisional application No. 61/068,063, filed on Mar. 3, 2008.

(51) Int. Cl. H01J 9/00

(52) U.S. Cl. 445/24

(57) ABSTRACT

A method of manufacturing a lighted sign from an electroluminescent panel having a plurality of layers that illuminate the panel when electrically energized. In one embodiment, the panel layers comprise a rear electrode, dielectric layer, phosphor layer, front electrode and transparent substrate layer. The method comprises the step of utilizing a laser to remove at least one of the panel layers from around a desired design shape such that only the design shape is illuminated when the panel is energized. In a preferred embodiment, the design shape is designed with a standard design program and the design shape is transmitted to a laser controller that controls the operation of the laser to remove the unwanted areas of the panel and quickly and inexpensively form the lighted sign. The laser can remove the rear electrode, all layers except the transparent layer or all layers from the unwanted areas of the panel.

### BACKGROUND OF THE INVENTION

A. Field of the Invention

The field of the present invention relates generally to methods and systems used to manufacture lighted signs. In particular, the present invention relates to methods of manufacturing a lighted sign from a single multiple layer electroluminescent panel. Even more particularly, this invention relates to such methods that remove one or more of the layers of an electroluminescent panel to provide the desired lighting design.

B. Background

Signs have been used for many years for advertising, messaging, visual art and other display purposes. Traditionally, most signs either have no lighting associated with the sign or have an external lamp associated therewith to shine light on the sign so that it may be seen at night or during low natural lighting conditions. Over the years, various types of lighting sign systems have been developed to provide lighted signs. For purposes of this disclosure, lighted signs include any type of sign or sign-like display that is utilized to display a message, an impression or other information, whether of a commercial, artistic, warning or other nature, to the person seeing the sign. As such lighted signs may be utilized to advertise a product, convey a personal or political message to others, decorate or otherwise enhance the appearance of another object, identify the location of a house, office or other place of business and/or for a variety of other display purposes.

Most presently available lighted sign systems utilize conventional electrical lamps, including standard light bulbs, LED bulbs, neon lighting, fiber optic lighting and the like, to provide the desired lighted display. These types of lighted signs have a number of limitations, including relatively high energy use, low lamp life, difficulty with use in or placement on many objects and inability to provide sufficiently precise control of the lighting for purposes of animating the display, which is a process by which different sections or areas of the sign are lit at different times to simulate action on the sign, in the desired manner. In order to achieve the desired lighting effect for lighted signs, some manufacturers have begun utilizing or attempting to utilize electroluminescent lamp lighting.

As well known to those skilled in the art, there are various types of electroluminescent lamp systems available. One such lamp is manufactured from multiple layer panels. For purposes of the present disclosure, an electroluminescent panel, hereinafter referred to as an “EL panel” is a sheet or sheet-like section of electroluminescent material that is comprised of multiple layers that function together to emanate light from the panel. A commonly available type of EL panel is made of inorganic materials and configured with electrodes which connect to a source of electrical power that provides electrical current which causes the electroluminescent material to emit light. Although a battery can be utilized as the power source, typically it is an AC or DC power source. A power inverter is commonly disposed between the power source and the EL panel to modify the electrical drive conditions supplied to the EL panel. For purposes of animating the EL panel, a switching unit is commonly utilized to selectively provide electric current to different sections or areas of the EL panel at different intervals.

As stated above, the typical EL panel is a made from a multiple layer electroluminescent material having a plurality of layers sandwiched together to effectively form a single unit. As set forth in U.S. Pat. No. 6,528,943 to Coghlan, et al. (hereinafter, the “'943 patent”), the layers of an EL panel typically comprise at least a pair of spaced apart electrodes, commonly referred to as a front electrode and a rear electrode, one or more layers having phosphor and dielectric materials disposed between the front and rear electrodes and an outer transparent plastic layer over the front electrode. The standard EL panel is effectively a capacitor having a dielectric layer disposed between two conductive electrodes, with one of the electrodes, typically the front electrode, being transparent. As well known, the phosphor material radiates light in response to an electric current being passed through it or in the presence of a strong electric field. One of the primary advantages of utilizing an EL panel is that it can radiate light with relatively little current, compared to other lamp systems.

One type of modern EL panel, described in the '943 patent, has a transparent front substrate layer, a transparent front electrode, a phosphor layer, a dielectric layer and an opaque rear electrode. The transparent front substrate is typically made out of a plastic material, such as a polyester (e.g., polyethylene terephthalate or PET) or polycarbonate material. The transparent front electrode is commonly made out of indium tin oxide and is vacuum deposited onto the front substrate layer. The phosphor layer, typically having encapsulated phosphor, is screen-printed over the front electrode. The dielectric layer, commonly containing a solvent, a binder and barium titanate particles, is screen-printed over the phosphor layer. The rear electrode, typically comprising a solvent, a binder and conductive particles such as silver or carbon, is then screen-printed over the dielectric layer. Due to the chemical compatibility of the layers, there is good adhesion between adjoining layers of the EL panel. One such EL panel is the duraELglo™ EL lamps from Durel, which is a division of the Rogers Corporation out of Chandler, Ariz. One feature of EL panels is that if any one or more of the layers are removed, then panel or any portion of panel where the layer or layers were removed will not light.

For use as a sign, EL panels are typically provided in a rectangular, square, round or other shaped section of electroluminescent material. The EL panels can be of any size and shape and may be joined with other panels for even longer lengths or provided in a roll. These panels are commonly referred to as large area EL panels. In order to be utilized for a lighted sign, it is necessary to either provide the EL panel in the desired sign shape, which can be letters, designs or various combinations thereof, or to modify the standard panel such that only the desired sign shape is illuminated. The EL panel is then wired or otherwise connected to the power source in a manner such that it lights up as desired (i.e., the entire sign at once or with animation). If animation is desired, the letters and/or shapes that make up the sign are selectively lit. One method of manufacturing a sign out of an EL panel is to manufacture the panel itself in the desired sign shape. Unfortunately, such manufacturing processes are relatively expensive, requiring the design to be developed from a CAD drawing and tooling built to make the panel in the desired design shape, all of which require excessive design, engineering and set-up expenses, and are generally not economically suitable for use to make signs for custom and one-off or low volume runs. In addition to the economic limitations, the state of the art for this technology is somewhat limited with regard to the smallness and/or amount of design detail that can be provided. Another method of using EL panels for a lighted sign is to bond one or more layers of an opaque material, such as a vinyl material, to the front substrate layer to cover and block the portion of the EL panel that is not desired to be lit in order form the desired design shape. This method requires the configuration and use of an additional material, which is cut to the negative of the design, and is also somewhat limited as to the detail that can be provided in the lighted sign. Yet another potential method of manufacturing a lighted sign out of an EL panel is to manufacture one or more layers in the desired shape and then include the shaped layer(s) in the sandwiched panel. For instance, one or more layers could be manufactured in the desired design shape or shapes and then incorporated into the production of the EL panel. It is believed that this method also has various limitations which prevent its widespread use for economically manufacturing lighted signs out of an EL panel.

What is needed, therefore, is an improved method of manufacturing a lighted sign out of an EL panel that reduces the cost, does not require the use of additional materials and allows somewhat smaller and more detailed design shapes compared to presently available manufacturing methods. The method of manufacturing lighted signs should allow a user to cut a desired design shape out of an EL panel, whether in a section or roll form, in a manner that is cost effective even for a single or a small number of custom signs, in addition to large runs. The manufacturing method should allow efficient use of the EL panel so as to reduce waste and cost. The manufacturing method should also be suitable for use with a variety of different types of commercially available design programs and apparatuses for obtaining the design.

### SUMMARY OF THE INVENTION

The method of manufacturing lighted signs from EL panels of the present invention provides the benefits and solves the problems identified above. That is to say, the present invention discloses a method of manufacturing lighted signs out of EL panels which allows the user to more quickly, efficiently and with relatively low cost obtain a desired sign shape out of a commercially available, multiple layer EL panel. The preferred method of manufacturing lighted signs of the present invention utilizes a laser to remove one or more layers of a multiple layer EL panel so as to selectively allow portions of the EL panel to light in the desired design shape. The method of manufacturing lighted signs of the present invention also allows the user to obtain a lighted sign having a design shape that includes or entirely comprises small and/or detailed design components from a standard, commercially available EL panel. The method of the present invention is adaptable for use with commercially available and generally easy to utilize design software and laser apparatuses, thereby allowing relatively unskilled persons to quickly and easily make a lighted sign from an EL panel. As such, the method of manufacturing lighted signs from EL panels of the present invention is particularly suited for widespread use of the method to make signs and allows a sign manufacturer to economically manufacture small numbers or even a single lighted sign of a custom design shape.

In a primary embodiment of the present invention, the method of manufacturing a lighted sign generally comprises the steps of supplying an EL panel having a plurality of layers, operating a laser to direct a laser beam onto the EL panel and removing at least one of the panel layers from one or more areas of the EL panel with the laser beam to form a design shape having one or more letters and/or one or more shapes. The areas having at least one of the layers of the EL panel removed will not illuminate when the lighted sign is electrically energized by a power source, thereby leaving only the design shape portion to illuminate, as desired. Typically, the panel layers of an EL panel will comprise a rear electrode, dielectric layer, phosphor layer, front electrode and transparent substrate layer. The laser can be operated utilizing a laser-kissing technique that removes just the rear electrode layer, all of the layers except the transparent substrate layer or all of the layers of EL panel in the unwanted areas, the areas around the design shape, of the EL panel. In another embodiment, the laser can be operated to remove the rear electrode, the dielectric layer and a portion of the phosphor layer utilizing the laser-kissing technique and then an acetone can be utilized to gently wipe away the remaining phosphor layer to expose the front electrode so that the user can electrically connect directly to the front electrode instead of a bus bar or the like that is normally utilized. This embodiment has the advantage of eliminating waste by facilitating less scrap and allowing for design shapes that would otherwise be distracted from by using a bus bar to electrically connect to a power source.

In a preferred embodiment, the desired design shape is created utilizing a readily available and easy to use design program and the laser is connected to a laser controller that receives the design shape and transmits design instructions to the laser, with transmission of the design shape instructions to the controller and/or to the laser being through wired or wireless connections. As such, the method of forming a lighted sign of the present invention can be accomplished by a person having relatively little skill in field of EL panels, laser technology and design programs. In one embodiment, the design shape has a plurality of apertures throughout the design shape, formed by removing one or more layers of the EL panel from the apertures, to reduce the amount of energy consumed by the lighted sign when it is energized by the power source. A switching mechanism can be utilized with the lighted sign to animate the design shape as desired.

Accordingly, the primary aspect of the present invention is to provide a method of manufacturing lighted signs out of EL panels that provides the benefits described above and solves the problems associated with presently available methods of manufacturing lighted signs out of EL panels.

It is an important aspect of the present invention to provide an improved method of manufacturing lighted signs out of EL panels that allows the user to quickly, efficiently and with relatively low cost manufacture a lighted sign having a desired design shape from a commercially available multiple layer EL panel.

It is also an important aspect of the present invention to provide a method of manufacturing lighted signs out of EL panels that allows the user to obtain a lighted sign having small and/or detailed designs from an EL panel utilizing commercially available design software and manufacturing apparatuses.

Another important aspect of the present invention is to provide a method of manufacturing lighted signs that is suitable for use by persons who are not highly skilled in the relevant technology so as to enable the method to be widely utilized and to be suitable for use to manufacture single or small runs of a custom lighted sign, in addition to large runs.

The above and other aspects and advantages of the present invention are explained in greater detail by reference to the attached figures and the description of the preferred embodiment which follows. As set forth herein, the present invention resides in the novel features of form, construction, mode of operation and combination of the above presently described and understood by the claims.

### BRIEF DESCRIPTION OF THE DRAWINGS

In the drawings which illustrate the preferred embodiments and the best modes presently contemplated for carrying out the present invention:

FIG. 1 is a cross-sectional side view of a prior art EL panel showing the multiple layers that define the EL panel;

FIG. 2 is a cross-sectional side view of a prior art EL panel having the phosphor and dielectric layers of the EL panel of FIG. 1 combined into a single intermediate layer;

FIG. 3 is a cross-sectional side view of the EL panel of FIG. 1 being acted upon by a laser to remove a portion of one of the layers according to a preferred embodiment of the method of the present invention;

FIG. 4 is a top plan view of a sign manufactured according to one embodiment of the method of the present invention wherein only the rear electrode layer is removed;

FIG. 5 is a top plan view of a sign manufactured according to an alternative embodiment of the method of the present invention wherein all of the layers except the transparent substrate layer are removed;

FIG. 6 is a top plan view of a sign manufactured according to an alternative embodiment of the method of the present invention wherein all of the layers are removed;

FIG. 8 is a chart summarizing the method of manufacturing a lighted sign according to a preferred embodiment of the present invention;

FIG. 9 is a top plan view of a sign manufactured according to an alternative embodiment of the method of the present invention so as to reduce the energy usage of the sign; and

FIG. 9 is a top plan view of a sign manufactured according to an alternative embodiment of the method of the present invention wherein all of the layers except the front electrode and the transparent substrate layer are removed and the bus bar is eliminated.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The accompanying figures are merely illustrative of one or more of the preferred embodiments and, as such, represent one or more ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein show certain apparatuses for forming the lighted sign and certain uses and configurations of the lighted sign formed according to the method of the present invention, those who are skilled in the art will readily understand that this is merely for purposes of simplifying the present disclosure and that the present invention is not so limited.

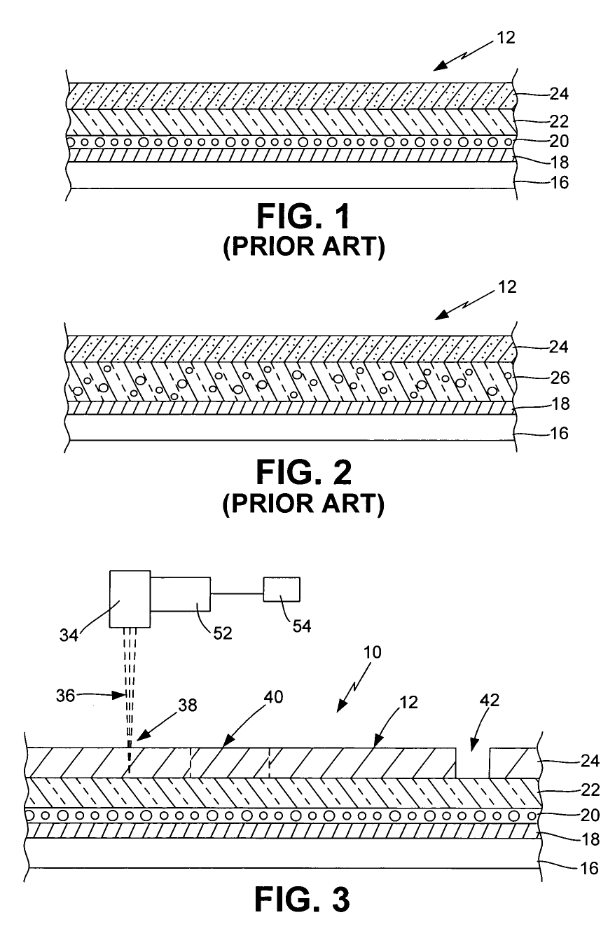

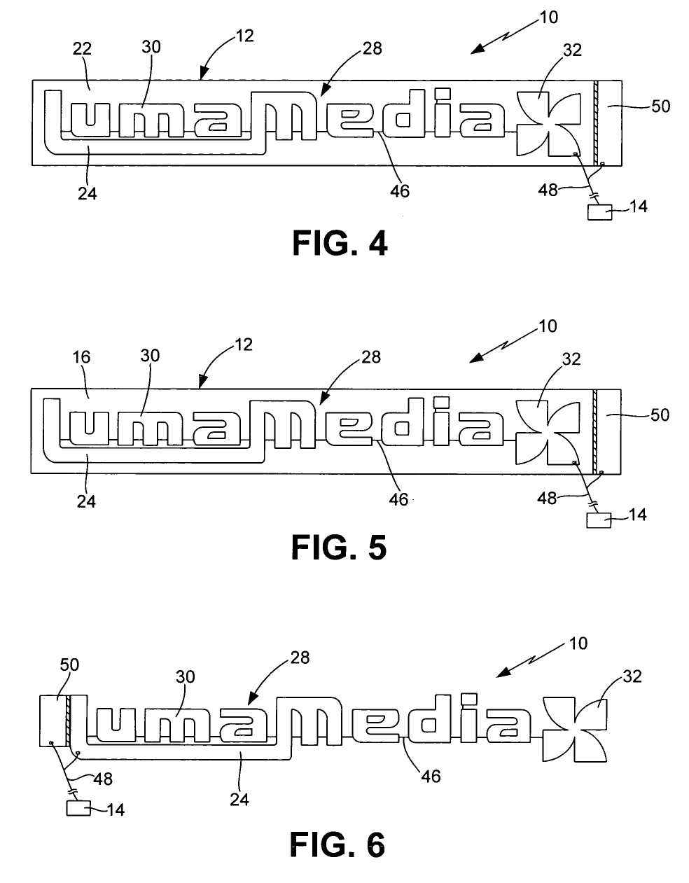

A lighted sign that is manufactured out of the materials and pursuant to embodiments of the present invention is shown generally as 10 in FIGS. 4 through 6 and 9. As set forth below, lighted sign 10 is manufactured from an EL panel 12, examples of which are shown in FIGS. 1 and 2, that has multiple layers sandwiched together to form a single functional unit which can be connected to a source of power 14 to cause the EL panel 12, or portions thereof, to light up. As set forth in the '943 patent, the disclosure of which is incorporated herein by this reference as though fully set forth in the present disclosure, a modern EL panel has a plurality of layers comprising a transparent front substrate layer 16, a transparent front electrode 18, a phosphor layer 20, a dielectric layer 22 and an opaque rear electrode 24, as shown in FIG. 1. The transparent front substrate 16 is typically made out of a plastic material, such as a polyester (e.g., polyethylene terephthalate or PET) or polycarbonate having a thickness of approximately 7.0 mils (0.178 mm). The transparent front electrode 18 is commonly made out of indium tin oxide that is vacuum deposited or otherwise placed onto the front substrate layer 16 to a thickness of approximately 1000 Å. The phosphor layer 20, which typically comprises encapsulated phosphor, is screen-printed over the front electrode 18. The dielectric layer 22, commonly containing a solvent, a binder and barium titanate particles, is screen-printed over the phosphor layer 20. In some EL panels, such as the panel shown in FIG. 2, the phosphor layer 20 and the dielectric layer 22 are combined into a single intermediate layer 26. The rear electrode 24, typically comprising a solvent, a binder and conductive particles such as silver or carbon, is screen-printed over the dielectric layer 22 or, if used, the intermediate layer 26. Due to the chemical compatibility of the layers, there is strong adhesion between adjoining layers of the EL panel 12. An example of an EL panel is the duraELglo™ EL lamps from Durel, which is a division of the Rogers Corporation out of Chandler, Ariz. One feature an EL panel 12 is that if any one or more of the layers are removed, then panel 12 or any portion of panel 12 where the layer or layers were removed will not light.

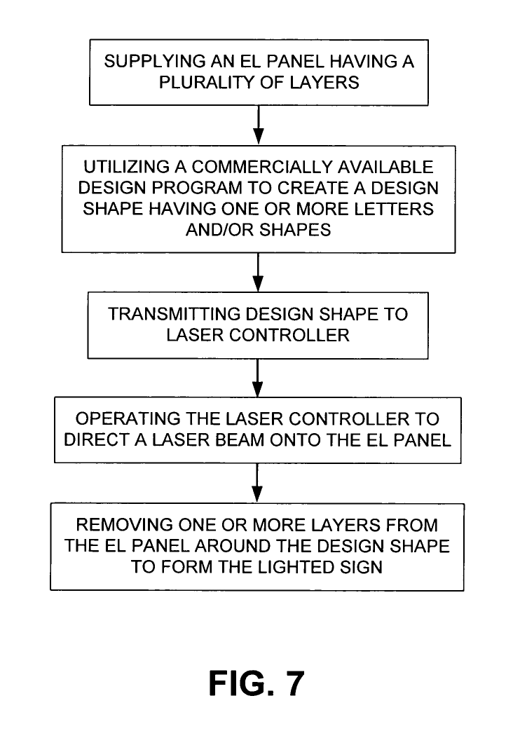

The method of manufacturing a lighted sign 10 of the present invention, shown in use in FIG. 3, comprises the step of removing one or more of the layers 16 through 24 of EL panel 12 (or layers 16, 18, 26 and 24) to provide a lighted sign 10 that has the desired design shape, examples of which are shown as 28 in FIGS. 4, 5, 6 and 9. As stated above, removing any one, more than one or all of the layers of the EL panel 12 from a portion of EL panel 12 (i.e., the area around the design shape 28) will result in that portion of EL panel 12 not being illuminated, leaving only the design shape 28 to illuminate, as is desired for lighted sign 10. When properly connected to the power supply 14, the portion or portions of the EL panel 12 remaining as the design shape 28 will light up as a unit or, if connected to a switching device, light up in the desired sequence to animate the lighted sign 10. As stated above, the design shape 28 can comprise letters 30 and/or shapes 32, in any desired combination, such as that shown in FIGS. 4 through 6 and 9. In the embodiment of FIG. 4, the layer comprising the rear electrode 24 was removed from around the design shape 28, leaving the dielectric layer 22 portion of the original EL panel 12 exposed. The portion of the rear electrode 24 not removed defines the desired design shape 28 and, when electrical energy is supplied thereto from power supply 14, will light up to provide the lighted sign 10. In the embodiment of FIG. 5, all layers of the EL panel 12 except the transparent substrate layer 16 were removed by the laser 34. In the embodiment of FIG. 6, all layers of EL panel 12 around the design shape 28 have been removed to form lighted sign 10. In the embodiment of FIG. 9, all layers except the front electrode 18 and the transparent substrate layer 16.

In the preferred embodiment of the present invention, a laser 34 is utilized to direct a cutting laser beam 36 toward EL panel 12 to remove the one or more layers of EL panel 12 that are necessary to be removed in order to form the lighted sign 10 having the desired design shape 28. As shown in FIG. 2, the laser 34 is cutting EL panel 12 at the cutting position shown as 38. The areas shown as 40 and 42 have been previously been cut by laser 34, with the area at 40 cut through to the outer edge of the EL panel 12 and the area at 32 not cut completely through to the outer edge of the EL panel 12. In the embodiment shown in FIG. 3, laser 34 is utilizing a process known as laser kiss-cutting to remove an outer layer of material, such as the rear electrode 24, without cutting into or removing the underlying material, such as the dielectric layer 22. The laser kiss-cutting process, which is generally well known in the art of laser technology and used in applications such as manufacturing stickers where the upper sticker portion is to be removed from the backing material, typically utilizes carbon dioxide lasers.

In a preferred embodiment of the method of the present invention, the laser 34 is utilized to remove one or more of the layers of the EL panel 12 having a plurality of such layers. The laser 34 can utilize the laser kiss-cutting technology to remove one or more of the layers 16 through 24 from around the design shape 28, as shown in FIGS. 3, 4 and 5, or laser 34 can be utilized to remove all of the layers 16 through 24 from around design shape 28, as shown in the lighted sign 10 of FIG. 6. In order for only the design shape 28 to illuminate in response to electricity from power source 14, the laser 34 must remove at least one of the layers 16 through 24, which will typically be rear electrode 24. Leaving one or more of the layers 14 through 22 (i.e., removing only the rear electrode 20 from around the design shape 24 as in FIG. 4), has the advantage of providing a stiffer lighted sign 10 that can be connected to the power source 14 and utilized like a sticker, except that it has the ability to light up and be animated. This is believed to be of significant benefit for purposes of conveying the message, advertising or other information or purpose of lighted sign 10 to those who will view it. Removing all of the layers 14 through 24 from around the design shape 28, as shown in FIG. 6, has the advantage of providing a more flexible lighted sign 10, similar in effect to a stencil, that can be more easily and smoothly placed around curved or otherwise non-planar surfaces, such as the side of motorcycle gas tank or the like. In a preferred embodiment of the present method, shown in FIG. 5, the laser 34 is utilized to remove all of the layers down to the transparent substrate layer 16, thereby removing the layers comprising the rear electrode 24, dielectric layer 22, phosphor layer 20 and front electrode 18 (or intermediate layer 26), around the design shape 28.

Whether removing one or more than one of the layers, the laser 34 is utilized to cut around the design shape 28 to remove what is not needed for the letters 30 and/or shapes 32. If the design shape 28 is to be lit as a whole, then the various letters 30 and/or shapes 32 that make up the design shape 28 must be connected by a small connecting element, shown as 46 on FIGS. 4 and 5, that electrically connects all of the letters 30 and/or shapes 32 to the power source 14, which is connected to lighted sign 10 by wires 48. In the preferred embodiment, the connecting element 46 is a thin portion of the EL panel 12 that has all of the layers intact so the electrical current will flow from one letter 30 and/or shape 32 to another. Preferably, the bus bar 50 section of the EL panel 12 is also left intact, as shown in FIGS. 4, 5 and 6. The bus bar 50 is utilized to connect to the power source 14, via wires 48, to power lighted sign 10.

Another alternative embodiment for lighted sign 10 is shown in FIG. 9. In this embodiment, all of the layers except the front electrode 18 and the transparent substrate layer 16 have been removed. As shown, this embodiment allows the user to eliminate the bus bar 50 by connecting one of the leads from wire 48 to the exposed front electrode 18 (the other lead being connected to rear electrode 24 as in the other embodiments) to complete the electrical circuit and light the design shape 28 when energized by power supply 14. One advantage of this embodiment is that eliminating bus bar 50 reduces waste by facilitating less scrap material. Another advantage of this embodiment is that elimination of the bus bar 50 and connecting directly to the exposed front electrode layer 18 allows for more varied design shapes 28, including round, oval, triangular and other shapes where having a small rectangular (or other shaped) bus bar 50 extending from the side may be detrimental to from the desired visual effect of the lighted sign 10. As with the other embodiments, removal of rear electrode 24, dielectric layer 22 and phosphor layer 20 (or intermediate layer 26) is best achieved by utilizing the laser-kissing technique with laser 34. Because it is important to not scar the front electrode 18 with the laser beam 36, the user should only kiss-cut with laser 34 down to the phosphor layer 20 or near the middle or bottom of phosphor layer 20 and then remove the rest of phosphor layer 20 with a chemical wash. In a preferred method, the user gently wipes the remaining portion of the phosphor layer 20 with acetone or the like. As known to those skilled in the art, other wash chemicals or techniques may be utilized to remove the remaining portion of the phosphor layer 20.

In a preferred embodiment, laser 34 is of the type that provides very fine cutting with pinpoint accuracy so that it can cleanly cut out design shape 28 leaving connecting elements 46 between the various design elements (e.g., the letters 30 and shapes 32) thereof as needed to provide the desired lighting effect and a laser controller 52 to control the operation and movement of the laser 34. The manufacturing method of the present invention has the benefit of being able to utilize commercially and readily available (i.e., non-special order) EL panels 12 and electronics. The method does not require the addition of any other materials to the EL panel 12 and reduces waste of electroluminescent material by allowing more efficient use of the entire EL panel 12. The method of manufacturing lighted signs 10 of the present invention is also suitable for use with large format EL panels 12, which can be utilized to manufacture larger sized lighted signs 10. As with EL panels 12, color mix can be applied to the front transparent substrate layer 12 to provide one or more color elements for the lighted sign 10.

In a preferred embodiment of the method of the present invention, the user can utilize a commercial design program 54, such as CorelDRAW® or the like, to create the design shape 28. The design information from the design program 28 is transmitted to the laser controller 52 and then the laser 34 so that laser 34 may cut the EL panel 12 to remove one or more layers of the EL panel in the area around the design shape 28 and, typically, connecting element 46. One major advantage of the method of the present invention is that relatively easy to learn and simple to use design programs 54 can be utilized to create the desired design shape 28. The laser 34 can be of the type that is substantially automated, perhaps only requiring EL panel 12 to be manually fed to laser 34 if an automatic feed apparatus is not utilized with laser 34. As such, the method of the present invention allows a person having relatively little skill with regard to graphic design programs, electroluminescent technology and lasers to utilize the method of the present invention to manufacture a lighted sign 10 having selective lighting from a standard EL panel 12.

The use of the method of the present invention is summarized in the chart of FIG. 7. In use, the user either obtains or is provided with a standard EL panel 12, which can be an off-the-shelf type of product, having multiple layers comprising at least a rear electrode 24, one or more intermediate layers 26 (i.e., combined or separate dielectric layer 22 and phosphor layer 20) and a front electrode 18. As stated above, typically there is also a transparent substrate layer 16 adjacent the front electrode 18. The user obtains the design shape 28 from the purchaser or he or she creates the design shape 28 using a design program 54, preferably of the type that is easy to use and common known. The information regarding the design shape 28 is electronically transmitted from the design program 54 to the laser controller 52, typically through a wired or wireless connection, and the EL panel 12 is fed to laser 34. The laser controller 52, which is operatively connected to the laser 34 through a wired or wireless connection, controls laser 34 to selectively direct a laser beam 36 toward the EL panel 12 to remove one or more layers of the EL panel 12 from around the design shape 28 to form lighted sign 10 from all or only a portion of the EL panel 12. Typically, at least rear electrode 24 is removed from the relevant portion(s) of the EL panel 12. In other preferred embodiments, each of the layers are removed down to the transparent substrate layer 16 or all of the layers 16 through 24 are removed. The wires 48, which will typically connect to bus bar 50 and elsewhere on lighted sign 10, are connected to a power source 14 to energize lighted sign 10. If desired, a switching unit can be connected to lighted sign 10 provide an animation effect for lighted sign 10.

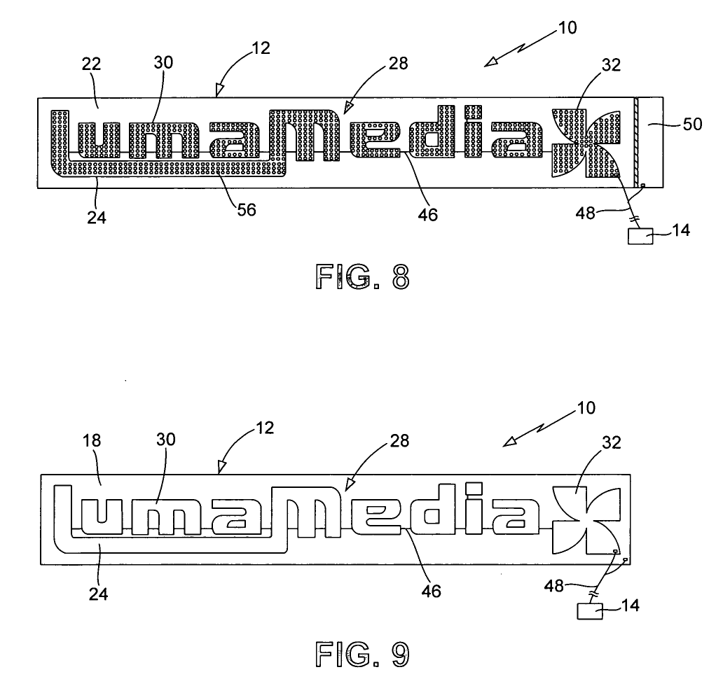

An alternative configuration of a lighted sign 10 manufactured from an EL panel 12 utilizing a slightly modified method of the present invention is shown in FIG. 8. In this embodiment, a plurality of apertures 56 are placed in the portion of EL panel 12 that makes up the design shape 28 (e.g., the portion not otherwise removed by laser 34). As with the area that does not make up the design shape 28, one or more of the layers of the EL panel 12 at the apertures 56 are removed, preferably by the laser-kissing technique described above. The purpose of the apertures 56 is to reduce the amount of complete EL panel 12 that will be energized by the power source 14 when the lighted sign 10 is in use to reduce the energy consumption of lighted sign 10. Preferably, the apertures 56 are relatively small holes in the letters 30 and/or shapes 32 that define the design shape 28 so that the remaining portion of the EL panel will sufficiently light the design shape 28 that most persons will not even notice that the apertures 56 are in the letters 30 and/or shapes 32 of the lighted sign 10. In one configuration of this embodiment, the inventors have found that apertures 56 having a diameter as large as 0.10 inch can be utilized without interfering with the purpose of the lighted sign 10. Depending on the size and configuration of the letters 30 and/or shapes 32 that make up the design shape 28, smaller or larger apertures 56 can be utilized. Depending on the size and quantity of apertures 56, the embodiment of FIG. 8 can significantly reduce the electrical consumption of lighted sign 10. The design program 54 can direct the laser controller 52 to control the laser 34 so as to direct the laser beam 36 to form the apertures 56 in the design shape 28 or the laser controller 52 can be configured to automatically produce the plurality of apertures 56 when forming the design shape 28. Alternatively, EL panel 12 can be provided with plurality of apertures 56 already in the EL panel 12, typically spread generally evenly across the EL panel 12, such that the desired design shape 28 having a plurality of apertures 56 is formed during the process of forming the design shape 28.

While there are shown and described herein specific forms of the invention, it will be readily apparent to those skilled in the art that the invention is not so limited, but is susceptible to various modifications and rearrangements in design and materials without departing from the spirit and scope of the invention. In particular, it should be noted that the method of the present invention is subject to modification with regard to any dimensional relationships set forth herein and modifications in assembly, materials, size, shape, and use. For instance, there are numerous components described herein that can be replaced with equivalent functioning components to accomplish the objectives of the present invention. In particular, those skilled in the art will readily appreciate that the configuration of the EL panel, laser controller and laser can be different than described above for the preferred embodiments.

What is claimed is:

1. A method of manufacturing a lighted sign, comprising the steps of:
a) supplying an EL panel having a plurality of layers comprising at least a rear electrode, one or more intermediate layers and a front electrode;
b) operating a laser to direct a laser beam onto said EL panel; and
c) removing at least one layer of said plurality of layers from one or more areas of said EL panel with said laser beam to form a design shape having one or more letters and/or one or more shapes.

2. The method of claim 1, wherein said removing step removes said rear electrode from said one or more areas to form said design shape.

3. The method of claim 1, wherein said removing step removes each of said plurality of layers from said one or more areas to form said design shape.

4. The method of claim 1, wherein said removing step removes said rear electrode and a portion of said intermediate layers, said remaining portion of said intermediate layers removed with a chemical wash to expose said front electrode.

5. The method of claim 1, wherein said plurality of layers comprises said rear electrode, a dielectric layer, a phosphor layer, said front electrode and a transparent substrate layer and said removing step removes said rear electrode, said dielectric layer, said phosphor layer and said front electrode from said area to form said design shape.

6. The method of claim 1 further comprising the step of utilizing a design program to form said design shape, design information from said design program electronically transmitted to said laser so as to direct said laser beam onto said EL panel to remove said at least one layer from said one or more areas to form said design shape.

7. The method of claim 6 further comprising a laser controller connected to said design program and said laser to receive design information from said design program and to control said laser so as to direct said laser beam to said one or more areas to remove said at least one layer of said EL panel and form said design shape.

8. The method of claim 1 further comprising a laser controller connected to said laser to receive to control said laser so as to direct said laser beam to said one or more areas to remove said at least one layer of said EL panel and form said design shape.

9. The method of claim 1, wherein said removing step is performed with a laser-kissing technique.

10. The method of claim 1, wherein said design shape comprises a plurality of apertures formed by the removal of one or more layers of said EL panel from said apertures to reduce the electrical power consumption of said lighted sign.

11. A method of manufacturing a lighted sign, comprising the steps of:
a) designing a design shape having one or more letters and/or one or more shapes with a design program;
b) transmitting said design shape to a laser;
c) operating said laser to direct a laser beam onto an EL panel having a plurality of layers comprising at least a rear electrode, a dielectric layer, a phosphor layer, a front electrode and a transparent substrate layer; and
d) removing at least one layer of said plurality of layers from one or more areas of said EL panel with said laser beam to form said design shape.

12. The method of claim 11, wherein said removing step is performed with a laser-kissing technique.

13. The method of claim 11, wherein said removing step removes said rear electrode from said one or more areas to form said design shape.

14. The method of claim 11, wherein said removing step removes each of said plurality of layers from said one or more areas to form said design shape.

15. The method of claim 11, wherein said removing step removes each of said rear electrode, said dielectric layer, said phosphor layer and said front electrode from said one or more areas to form said design shape.

16. The method of claim 11, wherein said removing step removes said rear electrode, said dielectric layer and a portion of said phosphor layer, said remaining portion of said phosphor layer removed with a chemical wash to expose said front electrode.

17. The method of claim 11 further comprising a laser controller connected to said design program and said laser to receive said design shape from said design program and to control said laser so as to direct said laser beam to said one or more areas to remove said at least one layer of said EL panel and form said design shape.

18. The method of claim 11, wherein said design shape comprises a plurality of apertures formed by the removal of one or more layers of said EL panel from said apertures to reduce the electrical power consumption of said lighted sign.

19. A method of manufacturing a lighted sign, comprising the steps of:
a) designing a design shape having one or more letters and/or one or more shapes with a design program;
b) transmitting said design shape to a laser controller operatively connected to a laser;
c) operating said laser to direct a laser beam onto an EL panel having a plurality of layers comprising at least a rear electrode, a dielectric layer, a phosphor layer, a front electrode and a transparent substrate layer; and
d) removing at least one layer of said plurality of layers from one or more areas of said EL panel with said laser beam utilizing a laser-kissing technique to form said design shape.

20. The method of claim 19, wherein said design shape comprises a plurality of apertures formed by the removal of one or more layers of said EL panel from said apertures to reduce the electrical power consumption of said lighted sign.
